(19) United States
(12) Patent Application Publication
(10) Pub. No.: US 2026/0212340 A1
(43) Pub. Date: Jul. 23, 2026

(54) VIRTUAL CARD IDENTIFIER IN A VERY SMART WALLET

(71) Applicant: Wells Fargo Bank, N.A., San Francisco, CA (US)

(72) Inventors: Clifford R. Bloom, Minneapolis, MN (US); Kami J. Hanson, Columbus, MN (US); Ryan Michael Hegland, Lakeville, MN (US)

(21) Appl. No.: 19/034,117

(22) Filed: Jan. 22, 2025

(51) Int. Cl. G06Q 20/34; G06Q 20/32; G06Q 20/36; G06Q 20/40

(52) U.S. Cl. CPC G06Q 20/351; G06Q 20/3278; G06Q 20/3672; G06Q 20/405

(57) ABSTRACT

Virtual card numbers within a mobile wallet includes receiving a request to generate a virtual card number, generating the number, and transmitting it with customizable restrictions to a payment processor. The mobile wallet displays the virtual card number for transactions. It also involves creating a mobile payment token, transmitting it via NFC, and using a mobile ID of a transacting party to ensure secure transactions.

### TECHNICAL FIELD

Embodiments pertain to digital payment systems. Some embodiments relate to the generation and utilization of virtual card numbers within mobile wallets for secure transactions.

### BACKGROUND

Payment card fraud is a widespread issue that affects both consumers and financial institutions. It involves unauthorized transactions made using stolen or counterfeit payment card information. Fraudsters employ various techniques to obtain card details, including skimming devices, phishing schemes, and data breaches. Once they have access to this information, they can make unauthorized purchases or withdraw funds from the victim's account. The impact of payment card fraud is significant, leading to financial losses for individuals and businesses, as well as increased costs for financial institutions due to fraud prevention and mitigation efforts.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a system diagram of a virtual card payment system involving a user device, merchant device, and payment system according to some examples of the present disclosure.

FIG. 2 shows a user device displaying a mobile wallet application interface with a virtual card creation option according to some examples of the present disclosure.

FIG. 3 shows the UI of a mobile wallet application displaying a generated virtual card number according to some examples of the present disclosure.

FIG. 4 shows a logical diagram of a user device, merchant device, and payment system component according to some examples of the present disclosure.

FIG. 5 shows a flowchart diagram illustrating a method for generating and utilizing a virtual card number within a mobile wallet according to some examples of the present disclosure.

FIG. 6 illustrates a block diagram of an example machine for implementing the techniques discussed according to some examples of the present disclosure.

### DETAILED DESCRIPTION

Virtual card numbers were developed to deal with payment card fraud on the Internet and are temporary, unique card numbers. Virtual card numbers are typically linked to the user's primary account number (PAN) but do not expose the actual card details, thereby protecting the user's financial information from potential breaches or misuse. Traditional virtual card systems, while offering enhanced security for online transactions, often face limitations that hinder their broader adoption and utility. For example, traditional virtual card systems may lack the ability to set granular restrictions, such as merchant-specific usage or precise spending limits, which can leave users vulnerable to certain types of fraud. Furthermore, the process of generating and managing multiple virtual card numbers can be cumbersome, leading to a less seamless user experience. Finally, these virtual card numbers are typically restricted to online purchases, rendering them unusable or inconvenient for in-person transactions at physical retail locations as they would require a user to type in a card number rather than using tap-to-pay or a physical card.

Modern mobile wallet payment solutions use tokenization to convert the primary account number (PAN) into a device account number (DAN). The DAN is then used, along with payment info, to create a dynamic cryptogram which is used for payment. While this enhances security, this DAN token does not allow restrictions related to merchants, spending limits, or the like. This reduces the flexibility and convenience of mobile wallet payments and increases a security risk in the event that the DAN is exposed.

Disclosed in some examples are methods, systems, devices, and machine-readable mediums for generating and utilizing virtual card numbers within a mobile wallet to enhance transaction security and user control. The invention allows users to create virtual card numbers with customizable restrictions, such as spending limits, expiration dates, and merchant-specific usage, directly from their mobile wallet. These virtual card numbers can be used for both online and in-person transactions, including tap-to-pay functionality, thereby providing a unified and secure payment solution. By leveraging the security features of the mobile wallet, the invention ensures that the virtual card numbers are protected from unauthorized use, reducing the risk of fraud and offering users greater peace of mind when making purchases.

In some examples, the use of very smart wallets (VSWs) that include mobile identities, such as a mobile driver's license (mDL) may further provide enhanced security. For example, the virtual card number may be set with restrictions that prevent a person who is not the payor and/or payee from using the virtual card number. These restrictions may be accomplished by utilizing the digital identification of the payee, payor, or both in the generation of the virtual card number or cryptogram (for tap-to-pay payments). For example, a bitstream of the digital identification of the payor and/or payee (or a portion of the digital identification) may be used as another field as input into the cryptogram generation algorithm (such as a SHA-256 algorithm). When the cryptogram is verified in the payment processor, the payment processor ensures the cryptogram includes the proper identification credentials by independently generating the cryptogram using the payor's and/or payee's digital identification to ensure the cryptogram provided with the payment matches the cryptogram generated independently.

In some examples, the virtual card number may include one or more digits that are based upon the digital identification (or a portion of the digital identification) of the payor or payee. For example, by inputting a bitstream representation of the digital id into a cryptographic hash algorithm such as SHA-256 and selecting specific bit positions of the output of the SHA-256 and inserting these into the virtual card number. In some examples, because the digital id of the user is embodied in the virtual card number, the mobile wallet may not have to contact the payment processor to provide the payment processor the virtual card number. In these examples, the payment processor may store pre-computed SHA-256 hashes of the subscriber's digital IDs and then utilize the specific bit positions of the virtual card number to match the virtual card number to the real PAN of the user. In some examples, where the payor's digital identity is also embodied within the virtual card number, the payment processor receives the payor's digital identity with the payment request. The payment processor then verifies that the SHA-256 of the payee and payor's digital identity is part of the virtual card number. In some examples, to secure the payor's and/or payee's digital id if that information is not private, the mobile wallet and the payment processor may utilize a common salt value (setup in advance) that is also input into the SHA-256 algorithm that obscures the ID, verifies that the number was generated by the user's mobile wallet, and prevents replay attacks.

For example, a pseudocode implementation of the above may include: FUNCTION generate_virtual_card_number(payor_id, payee_id, salt, base_virtual_number):
combined_id=payor_id+payee_id+salt
bitstream=convert combined_id to bitstream
hash_digest=SHA-256(bitstream)
selected_bits=extract specific bits from hash_digest
virtual_card_number=concatenate base_virtual_number with selected_bits+random number//base virtual number is provided by the payment service

RETURN virtual_card_number

FUNCTION verify_virtual_card_number(virtual_card_number, payor_id, payee_id, salt):
combined_id=payor_id+payee_id+salt
bitstream=convert combined_id to bitstream
hash_digest=SHA-256(bitstream)
expected_bits=extract bits from virtual_card_number

RETURN expected_bits==selected bits from hash_digest

In other examples, instead of, or in addition to utilizing digital identifiers to create the virtual card number or cryptogram, a payees digital ID may be obtained by a user's mobile wallet (e.g., as part of the transaction) and sent to the payment processor along with the virtual card number. The payment processor may tie the virtual card number to that id in the database of the payment processor. When seeking payment, the payee provides this digital ID to the payment service. If the digital ID matches the ID tied to the virtual card, the payee is paid. If the digital ID provided does not match, the payee is not paid.

In some examples, a user may explicitly cancel a virtual card number. The mobile wallet may send a cancellation message to a payment processor in response to receiving a request to cancel the virtual card number. The payment processor then removes an entry associating the virtual card number with the user's account.

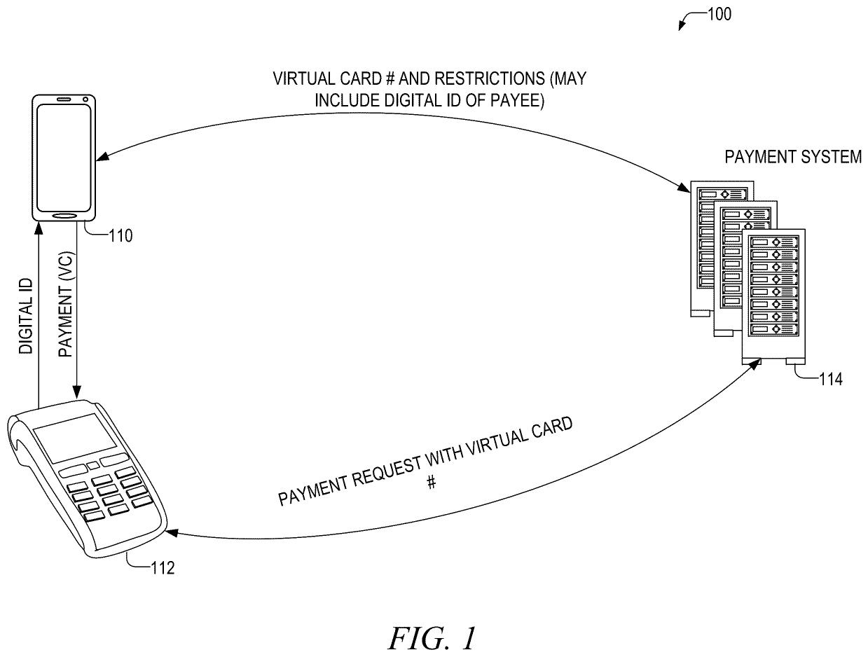

FIG. 1 shows a system 100 of a virtual card payment system according to some examples of the present disclosure. A user device 110 interacts with a merchant device 112 and a payment system 114. A mobile wallet of the user device 110 is configured to cause generation of a virtual card number (VC) and transmit the virtual card number along with any customizable restrictions to the payment system 114. The payment system 114 associates the virtual card number and any customizable restrictions with the user's account. For example, the user may send the Device Account Number (DAN) of the mobile payment element (e.g., the token) along with the virtual card number. The payment system 114 may lookup the DAN to find the Primary Account Number (PAN) of the account and then make an entry with the VC. The generation of the virtual card number may involve an algorithm provided by the payment system 114 and may be based on the payment element (e.g. the DAN), regular card number, and/or the digital ID of the payee.

In other examples, the virtual card number may be generated by the payment system 114 and communicated to the user device 110 instead of the virtual card number being generated by the user device 110 and sent to the payment system 114. In still other examples, some digits of the virtual number may be generated by the payment system 114 and some digits may be generated by the user device 110.

During a payment, the merchant device 112 receives the virtual card number from the user device 110. The merchant device 112 then sends a payment request with the virtual card number to the payment system 114. The payment system 114 processes the payment request, verifying the virtual card number, which may include the digital ID of the payee. The payment system 114 may also verify the spending limits, expiration dates, and merchant specific limitations on the virtual card number. For example, by referencing a data structure stored in association with the user's account and/or the table mapping the PAN to the virtual card numbers. These restrictions, as shown in FIG. 1 may be sent from the user device 110 to the payment system 114 when the user device 110 sets up the virtual card number.

In some examples, as noted, for additional security, the system may utilize the digital identification of the payor or payee (e.g., merchant device 112) to generate the virtual card number. In some examples, the digital identification of the payee may be or include a merchant id on the payment system 114. This ties the identity of the merchant to the virtual card number to prevent usage of the virtual card number with other merchants. In these examples, the user device 110 first receives the payee's digital identifier. The user device 110 and/or the payment system 114 then generates a virtual card number using the payor and/or payee's digital ID (such as a mobile driver's license (mDL)).

The user then provides the virtual card number to the payee either through NFC or manually. The payee (e.g., the merchant) may then utilize the merchant device 112 to submit a payment request to the payment system 114 along with the digital identifier of the payee (such as the merchant). The payment system 114 then verifies whether the virtual card number matches the expected number given the payor's digital ID and the payee's digital ID. If the number matches, the payment system 114 pays the payee, otherwise the transaction is declined.

The system 100 thus facilitates secure transactions by enabling users to generate virtual card numbers with customizable restrictions, enhancing both security and user control. When a user initiates the creation of a virtual card number, the mobile wallet application allows them to set specific parameters such as spending limits, expiration dates, and merchant-specific usage. These parameters are embedded within the virtual card number, ensuring that any transaction using this number adheres to the predefined restrictions.

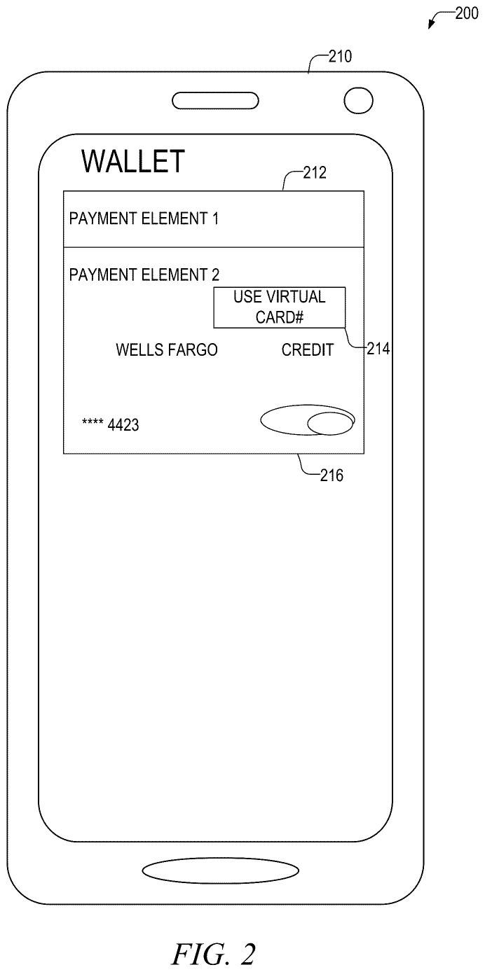

FIG. 2 shows a user device 210 displaying a user interface (UI) of a mobile wallet application. The UI includes a payment element 1 212 and a payment element 2 216. The payment element 2 216 displays a virtual card creation UI element 214 labeled “USE VIRTUAL CARD #”. This UI element allows the user to generate a virtual card number for secure transactions.

The payment element 2 216 also shows a masked card number (**** 4423) and the associated financial institution (Wells Fargo) along with the card type (Credit). The virtual card creation UI element 214 provides an option for the user to create a virtual card number, which can be used for transactions without exposing the user's real card number.

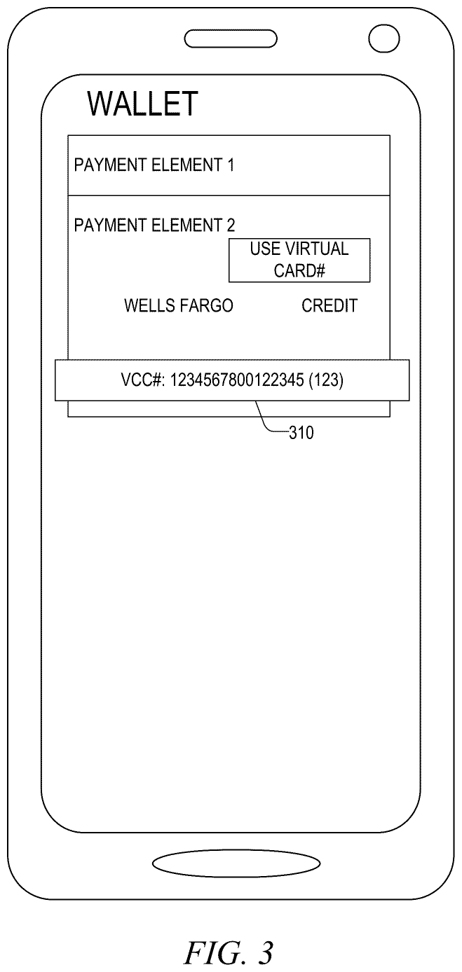

FIG. 3 shows the UI of FIG. 2 after the virtual card creation UI element is selected and a virtual card number is shown according to some examples of the present disclosure. The user interface displays a wallet application with two payment elements. Payment element 1 is shown at the top, followed by payment element 2. Payment element 2 includes a virtual card creation UI element labeled “USE VIRTUAL CARD #”. This UI element allows the user to generate a virtual card number for secure transactions.

Upon selecting the virtual card creation UI element, the user interface displays a virtual card number VCC #310. The virtual card number is shown as “1234567800122345 (123)”. This virtual card number is not the real card number of the user, providing an additional layer of security by preventing exposure of the user's primary card details. The virtual card number can be used for transactions, including both online and in-person purchases, without compromising the user's actual card information. The virtual card number may also include customizable restrictions such as spending limits, expiration dates, and merchant-specific usage, enhancing control over how and where the card details are used. In some examples, by tapping on the virtual card number 310, the virtual card number may be utilized in the next tap-to-pay payment.

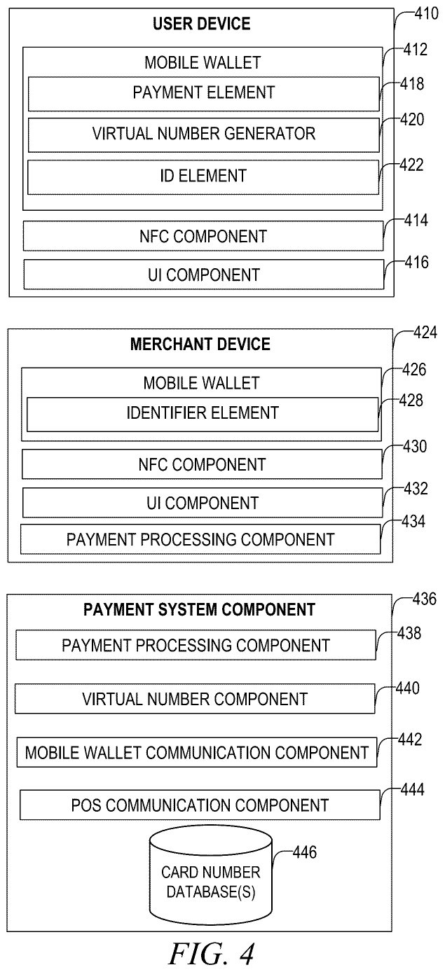

FIG. 4 shows a logical diagram of a user device 410, merchant device 424, and payment system 436 according to some examples of the present disclosure. The user device 410 includes a mobile wallet 412 having a payment element 418, a virtual number generator 420, and an ID element 422; an NFC component 414; and a UI component 416. The mobile wallet 412 manages the user's payment information and facilitates transactions. The payment element 418 allows the user to initiate payments. The virtual number generator 420 creates virtual card numbers for secure transactions and displays the virtual card numbers within the UI of the mobile wallet. Virtual number generator 420 may also create the cryptogram for use in tap-to-pay payments using virtual card numbers. The ID element 422 stores and manages the user's identification information. The NFC component 414 enables near-field communication for contactless payments and for providing ID information wirelessly. The UI component 416 provides the user interface for interacting with the mobile wallet 412 and other components.

The merchant device 424 includes a mobile wallet 426, an identifier element 428, an NFC component 430, a UI component 432, and a payment processing component 434. The mobile wallet 426 manages the merchant's payment information and facilitates transactions. The identifier element 428 stores and manages the merchant's identification information. The NFC component 430 enables near-field communication for contactless payments. The UI component 432 provides the user interface for interacting with the mobile wallet 426 and other components. The payment processing component 434 processes payment transactions received from the user device 410 by interacting with the user device 410 and the payment system 436.

The payment system 436 includes a payment processing component 438, a virtual card component 440, a mobile wallet communication component 442, and a POS communication component 444. The payment processing component 438 processes payment transactions and verifies the virtual card numbers and any associated restrictions. The virtual card component 440 creates, in some examples, virtual card numbers for secure transactions and associates the number, along with restrictions entered by the user, with the user's account into a database for future use. In other examples, the virtual card component 440 receives the virtual card number from the mobile wallet and enters the virtual card number along with restrictions entered by the user, with the user's account into a database for future use.

The mobile wallet communication component 442 facilitates communication between the mobile wallet of the user device 410 and the payment system 436. For example, to receive the virtual card numbers, restrictions, and identifier of the payee. The POS communication component 444 manages communication with point-of-sale devices for processing transactions, including receiving digital identity information. The card number database 446 stores card numbers and virtual card numbers for each account.

As an example use of the system, a user opens their mobile wallet 412 on the user device 410. The UI component 416 provides a user interface listing all the various payment elements, such as payment element 418. The user selects the payment element 418, which includes an option to generate a virtual card number. Upon selecting this option, the virtual number generator 420 within the mobile wallet 412 generates a virtual card number, either by itself using an algorithm, or by communicating with the virtual card component 440 of the payment system 436. The UI component 416 provides options for the user to set customizable restrictions, such as spending limits, expiration dates, and merchant-specific usage, through the UI component 416. In some examples, each payment card, as defined by the payment system 436, may have a set of possible payment parameters defined by a parameters data structure sent by the payment system 436. The virtual card number and the associated restrictions are then sent to the payment system 436 via the mobile wallet communication component 442 for storage in the card number database 446.

When the user is ready to make a purchase, they use either the NFC component 414 to transmit the virtual card number to the merchant device 424, or manually read off the virtual card number from the UI. The merchant device 424, which may include its own mobile wallet 426, receives the virtual card number through its NFC component 430, or through a UI component 432. In some examples, the identifier element 428 in the merchant device 424 may be provided to the user device 410 prior to receipt of the virtual card number to allow the user device 410 to create a virtual card number that is tied to a digital identifier of the merchant. The digital id of the merchant may be a cryptographically signed digital id in the same way that a mobile driver's license (mDL) works. The merchant device 424 then sends a payment request, including the virtual card number and in some examples, the merchant's digital identifier, to the payment system 436.

The POS communication component 444 within the payment system 436 receives the payment request and passes it to the payment processing component 438. The payment processing component 438 utilizes the virtual card component 440 to verify the virtual card number and any associated restrictions, such as the digital identity of the merchant by referencing the card number database 446. For example, the virtual card component 440 decrypts the digital signature using the identity of the digital identity issuer and verifies the credentials as well as verifying that the digital identity is the same one that is tied to the virtual card number. Upon verifying that the payment is allowed under the restrictions, the payment processing component 438 processes the payment.

While FIG. 4 illustrated a merchant device 424, such as a POS system, in other examples, the merchant device 424 may be another user device 410 in a P2P payment scenario.

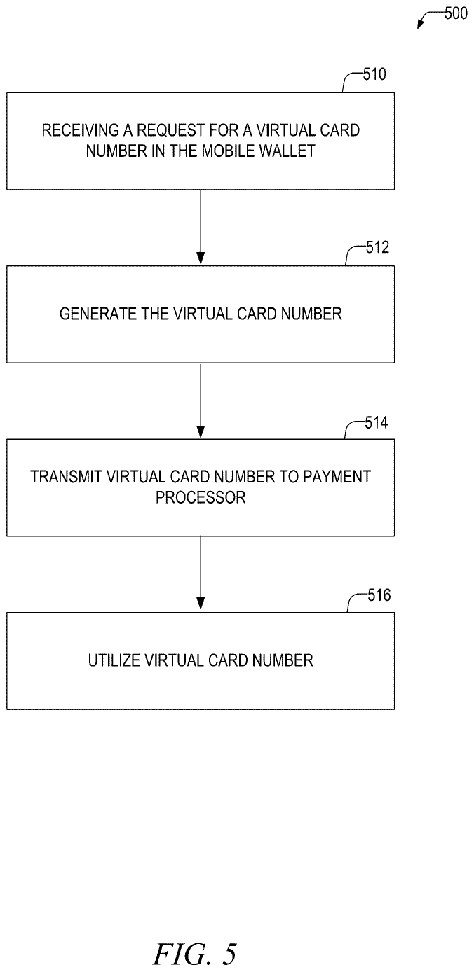

FIG. 5 shows a flowchart 500 of a method of a mobile wallet providing a virtual card number according to some examples of the present disclosure. The method begins with receiving a request for a virtual card number in the mobile wallet at operation 510. The mobile wallet application receives this request from a user through a user interface element such as a button, control, or other input modality. This step initiates the process of generating a virtual card number. At this stage, the mobile wallet application may also receive a payment restriction from the user. The payment restriction can include at least one of a spending limit, an expiration date, or a merchant-specific usage restriction.

Next, the method proceeds to generate the virtual card number at operation 512. The mobile wallet application generates the virtual card number, ensuring that the virtual card number is not the real card number of the user. This step provides an additional layer of security by preventing exposure of the user's primary card details. In some examples, generating the virtual card number may involve contacting the payment processor to assist in the generation process.

Following the generation of the virtual card number, the method involves transmitting the virtual card number to a payment processor at operation 514. The mobile wallet application transmits the virtual card number along with any customizable restrictions to the payment processor. This transmission allows the payment processor to associate the virtual card number and any customizable restrictions with the user's account. This step may also involve creating a mobile payment token utilizing the virtual card number and transmitting the mobile payment token to the payment processor. Additionally, the mobile payment token can be transmitted to a merchant using near-field communications (NFC).

The final step in the method is to utilize the virtual card number at operation 516—such as by causing a payment to be made—either by displaying the virtual card number or transmitting it to another device.

The mobile wallet application may also provide an option for the user to invalidate the virtual card number. The user can indicate through the UI that the virtual number is to be invalidated, and the mobile wallet application will send a command to invalidate the virtual number to the payment processor.

Additionally, the method may involve receiving a mobile ID of a transacting party from a transacting party computing device. The mobile wallet application provides the mobile ID to the payment processor along with the virtual card number. The payment processor only allows transactions with the virtual card number from the transacting party when the mobile ID is provided to the payment processor with the transaction.

In some examples, the system may be utilized in a peer-to-peer (P2P) payment scenario to enhance security and prevent misuse of virtual card numbers. In this scenario, a one-time token is created using the ID in the mobile wallet and the virtual card number, ensuring that the virtual card number can only be used for a single transaction with a specific individual. For instance, when a user wishes to send money to another person, the mobile wallet application generates a virtual card number and associates it with a one-time token. This token is then tied to the recipient's digital ID, such as a mobile driver's license (mDL) stored in their mobile wallet.

During the transaction, the sender's mobile wallet transmits the virtual card number and the one-time token to the recipient's device. The recipient's device verifies the token and the associated virtual card number against their digital ID. If the digital ID matches the one tied to the token, the transaction is authorized, and the funds are transferred. This process ensures that the virtual card number cannot be reused or misappropriated by unauthorized parties, providing a secure method for P2P payments. In some examples, the recipient's device may then provide the token and virtual card number to the payment processor to initiate the funds transfer.

In another example, the system may be applied to peer-to-business (P2B) transactions, providing a secure and verifiable method for business transactions. In this scenario, a government agency or other authoritative entity could issue a business license that functions similarly to a mobile driver's license (mDL). This business license would include digital identities to allow businesses to verify their identity for transactions.

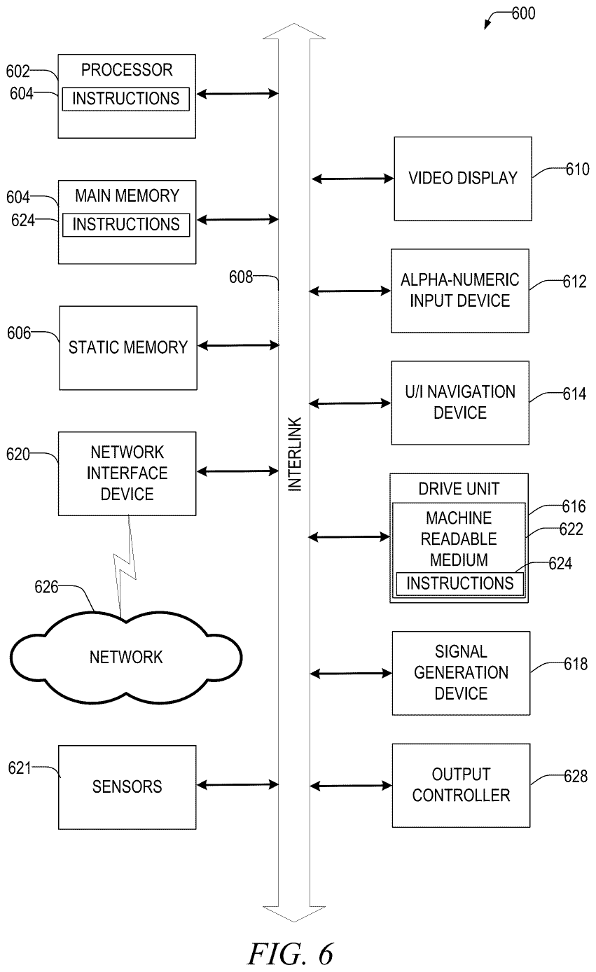

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be in the form of a mobile device, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The machine 600 may be configured to be the user devices 110, 210, 410; the merchant device 112 and 424; or one or more devices of the payment system 114, 436. Machine 600 may provide the GUIs of FIGS. 2 and 3, and the method of FIG. 5.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 600 may include one or more hardware processors, such as processor 602. Processor 602 may be a central processing unit (CPU), a graphics processing unit (GPU), a hardware processor core, or any combination thereof. Machine 600 may include a main memory 604 and a static memory 606, some or all of which may communicate with each other via an interlink (e.g., bus) 608. Examples of main memory 604 may include Synchronous Dynamic Random-Access Memory (SDRAM), such as Double Data Rate memory, such as DDR4 or DDR5. Interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

### OTHER NOTES AND EXAMPLES

Example 1 is a computer-implemented method for generating and utilizing virtual card numbers within a mobile wallet, the method comprising: receiving, by a mobile wallet application, a request from a user, through a user interface element, to generate a virtual card number and a payment restriction on the virtual card number; generating, by the mobile wallet application, the virtual card number, wherein the virtual card number is not a same number as a card number of the user, the virtual card number generated based upon a digital identification of the user, a digital identification of a payee, and a random value; transmitting, by the mobile wallet application, the virtual card number and the payment restriction to a payment processor; and causing use, by the mobile wallet application, of the virtual card number in a transaction with the payee.

In Example 2, the subject matter of Example 1 includes, wherein the payment restriction includes at least one of a spending limit, an expiration date, or a merchant-specific usage restriction.

In Example 3, the subject matter of Examples 1-2 includes, creating a mobile payment cryptogram utilizing the virtual card number. and transmitting the cryptogram to a second computing device using near-field communications (NFC).

In Example 4, the subject matter of Example 3 includes, where the second computing device is a point-of-sale device of a merchant.

In Example 5, the subject matter of Examples 1-4 includes, receiving an indication from a UI of the mobile wallet, that the virtual card number is to be invalidated; and sending a command to invalidate the virtual card number to the payment processor.

In Example 6, the subject matter of Examples 1-5 includes, receiving, from a transacting party computing device, a mobile ID of a transacting party; and providing the mobile ID to the payment processor along with the virtual card number, the payment processor only allowing transactions with the virtual card number from the transacting party when the mobile ID is provided to the payment processor with the transaction.

In Example 7, the subject matter of Examples 1-6 includes, wherein generating, by the mobile wallet application, the virtual card number comprises contacting the payment processor to associate the virtual card number with the card number of the user.

Example 8 is a computing device for generating and utilizing virtual card numbers within a mobile wallet, the computing device comprising: a hardware processor; a memory, the memory storing instructions, which when executed by the hardware processor cause the computing device to perform operations comprising: receiving a request from a user, through a user interface element, to generate a virtual card number and a payment restriction on the virtual card number; generating the virtual card number, wherein the virtual card number is not a same number as a card number of the user, the virtual card number generated based upon a digital identification of the user, a digital identification of a payee, and a random value; transmitting the virtual card number and the payment restriction to a payment processor; and causing use of the virtual card number in a transaction with the payee.

In Example 9, the subject matter of Example 8 includes, wherein the operations further comprise: wherein the payment restriction includes at least one of a spending limit, an expiration date, or a merchant-specific usage restriction.

In Example 10, the subject matter of Examples 8-9 includes, wherein the operations further comprise: creating a mobile payment cryptogram utilizing the virtual card number; and transmitting the cryptogram to a second computing device using near-field communications (NFC).

In Example 11, the subject matter of Example 10 includes, wherein the operation of transmitting the cryptogram further comprises: wherein the second computing device is a point-of-sale device of a merchant.

In Example 12, the subject matter of Examples 8-11 includes, wherein the operations further comprise: receiving an indication from a UI of the mobile wallet, that the virtual card number is to be invalidated; and sending a command to invalidate the virtual card number to the payment processor.

In Example 13, the subject matter of Examples 8-12 includes, wherein the operations further comprise: receiving, from a transacting party computing device, a mobile ID of a transacting party; and providing the mobile ID to the payment processor along with the virtual card number, the payment processor only allowing transactions with the virtual card number from the transacting party when the mobile ID is provided to the payment processor with the transaction.

In Example 14, the subject matter of Examples 8-13 includes, wherein the operation of generating the virtual card number further comprises: contacting the payment processor to associate the virtual card number with the card number of the user.

Example 15 is a machine-readable medium, storing instructions for generating and utilizing virtual card numbers within a mobile wallet, the instructions, which when executed, cause the machine to perform operations comprising: receiving a request from a user, through a user interface element, to generate a virtual card number and a payment restriction on the virtual card number; generating the virtual card number, wherein the virtual card number is not a same number as a card number of the user, the virtual card number generated based upon a digital identification of the user, a digital identification of a payee, and a random value; transmitting the virtual card number and the payment restriction to a payment processor; and causing use of the virtual card number in a transaction with the payee.

In Example 16, the subject matter of Example 15 includes, wherein the operations further comprise: wherein the payment restriction includes at least one of a spending limit, an expiration date, or a merchant-specific usage restriction.

In Example 17, the subject matter of Examples 15-16 includes, wherein the operations further comprise: creating a mobile payment cryptogram utilizing the virtual card number; and transmitting the cryptogram to a second computing device using near-field communications (NFC).

In Example 18, the subject matter of Example 17 includes, wherein the operation of transmitting the cryptogram further comprises: wherein the second computing device is a point-of-sale device of a merchant.

In Example 19, the subject matter of Examples 15-18 includes, wherein the operations further comprise: receiving an indication from a UI of the mobile wallet, that the virtual card number is to be invalidated; and sending a command to invalidate the virtual card number to the payment processor.

In Example 20, the subject matter of Examples 15-19 includes, wherein the operations further comprise: receiving, from a transacting party computing device, a mobile ID of a transacting party; and providing the mobile ID to the payment processor along with the virtual card number, the payment processor only allowing transactions with the virtual card number from the transacting party when the mobile ID is provided to the payment processor with the transaction.

In Example 21, the subject matter of Examples 15-20 includes, wherein the operation of generating the virtual card number further comprises: contacting the payment processor to associate the virtual card number with the card number of the user.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A computer-implemented method for generating and utilizing virtual card numbers within a mobile wallet, the method comprising:
receiving, by a mobile wallet application, a request from a user, through a user interface element, to generate a virtual card number and a payment restriction on the virtual card number;
generating, by the mobile wallet application, the virtual card number, wherein the virtual card number is not a same number as a card number of the user, the virtual card number generated based upon a digital identification of the user, a digital identification of a payee, and a random value;
transmitting, by the mobile wallet application, the virtual card number and the payment restriction to a payment processor; and
causing use, by the mobile wallet application, of the virtual card number in a transaction with the payee.

2. The method of claim 1, wherein the payment restriction includes at least one of a spending limit, an expiration date, or a merchant-specific usage restriction.

3. The method of claim 1, further comprising:
creating a mobile payment cryptogram utilizing the virtual card number; and
transmitting the cryptogram to a second computing device using near-field communications (NFC).

4. The method of claim 3, where the second computing device is a point-of-sale device of a merchant.

5. The method of claim 1, further comprising:
receiving an indication from a UI of the mobile wallet, that the virtual card number is to be invalidated; and
sending a command to invalidate the virtual card number to the payment processor.

6. The method of claim 1, further comprising:
receiving, from a transacting party computing device, a mobile ID of a transacting party; and
providing the mobile ID to the payment processor along with the virtual card number, the payment processor only allowing transactions with the virtual card number from the transacting party when the mobile ID is provided to the payment processor with the transaction.

7. The method of claim 1, wherein generating, by the mobile wallet application, the virtual card number comprises contacting the payment processor to associate the virtual card number with the card number of the user.

8. A computing device for generating and utilizing virtual card numbers within a mobile wallet, the computing device comprising:
a hardware processor;
a memory, the memory storing instructions, which when executed by the hardware processor cause the computing device to perform operations comprising:
receiving a request from a user, through a user interface element, to generate a virtual card number and a payment restriction on the virtual card number;
generating the virtual card number, wherein the virtual card number is not a same number as a card number of the user, the virtual card number generated based upon a digital identification of the user, a digital identification of a payee, and a random value;
transmitting the virtual card number and the payment restriction to a payment processor; and
causing use of the virtual card number in a transaction with the payee.

9. The computing device of claim 8, wherein the operations further comprise:
wherein the payment restriction includes at least one of a spending limit, an expiration date, or a merchant-specific usage restriction.

10. The computing device of claim 8, wherein the operations further comprise:
creating a mobile payment cryptogram utilizing the virtual card number; and
transmitting the cryptogram to a second computing device using near-field communications (NFC).

11. The computing device of claim 10, wherein the operation of transmitting the cryptogram further comprises:
wherein the second computing device is a point-of-sale device of a merchant.

12. The computing device of claim 8, wherein the operations further comprise:
receiving an indication from a UI of the mobile wallet, that the virtual card number is to be invalidated; and
sending a command to invalidate the virtual card number to the payment processor.

13. The computing device of claim 8, wherein the operations further comprise:
receiving, from a transacting party computing device, a mobile ID of a transacting party; and
providing the mobile ID to the payment processor along with the virtual card number, the payment processor only allowing transactions with the virtual card number from the transacting party when the mobile ID is provided to the payment processor with the transaction.

14. The computing device of claim 8, wherein the operation of generating the virtual card number further comprises:
contacting the payment processor to associate the virtual card number with the card number of the user.

15. A machine-readable medium, storing instructions for generating and utilizing virtual card numbers within a mobile wallet, the instructions, which when executed, cause the machine to perform operations comprising:
receiving a request from a user, through a user interface element, to generate a virtual card number and a payment restriction on the virtual card number;
generating the virtual card number, wherein the virtual card number is not a same number as a card number of the user, the virtual card number generated based upon a digital identification of the user, a digital identification of a payee, and a random value;
transmitting the virtual card number and the payment restriction to a payment processor; and
causing use of the virtual card number in a transaction with the payee.

16. The machine-readable medium of claim 15, wherein the operations further comprise:
wherein the payment restriction includes at least one of a spending limit, an expiration date, or a merchant-specific usage restriction.

17. The machine-readable medium of claim 15, wherein the operations further comprise:
creating a mobile payment cryptogram utilizing the virtual card number; and
transmitting the cryptogram to a second computing device using near-field communications (NFC).

18. The machine-readable medium of claim 17, wherein the operation of transmitting the cryptogram further comprises:
wherein the second computing device is a point-of-sale device of a merchant.

19. The machine-readable medium of claim 15, wherein the operations further comprise:
receiving an indication from a UI of the mobile wallet, that the virtual card number is to be invalidated; and
sending a command to invalidate the virtual card number to the payment processor.

20. The machine-readable medium of claim 15, wherein the operations further comprise:
receiving, from a transacting party computing device, a mobile ID of a transacting party; and
providing the mobile ID to the payment processor along with the virtual card number, the payment processor only allowing transactions with the virtual card number from the transacting party when the mobile ID is provided to the payment processor with the transaction.
